(19) United States
(12) Patent Application Publication
(10) Pub. No.: US 2007/0098096 A1
(43) Pub. Date: May 3, 2007

(54) WIRELESS TRANSMITTER, SIGNAL TO SUBCARRIER ALLOCATION METHOD FOR SYNCHRONIZING SYMBOL, AND WIRELESS RECEIVER

(76) Inventors: Koji AKITA, Yokohama-shi (JP); Koichiro Ban, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/548,560

(22) Filed: Oct. 11, 2006

Related U.S. Application Data
(63) Continuation of application No. PCT/JP06/31627, filed on Aug. 14, 2006.

(30) Foreign Application Priority Data
Oct. 31, 2005 (JP) 2005-317681

(51) Int. Cl. H04K 1/10

(52) U.S. Cl. 375/260

(57) ABSTRACT

A wireless transmitter for transmitting an OFDM symbol including a first generator to generate a plurality of first signals each including a stationary signal, a second generator to generate a plurality of second signals whose total power is less than that of the first signals, and an allocation unit configured to allocate the first signals to the ±N*k (N: an integral number not less than or equal to 2, k=1, 2, . . . ) th first subcarriers of a synchronizing symbol and to allocate the second signals to at least some second subcarriers of the synchronizing symbol, a generating unit configured to generates a signal of an OFDM symbol including the synchronizing symbol in which the first signals and the second signals are allocated into the first subcarriers and the second subcarriers, and a transmission unit configured to transmit the signal of the OFDM symbol.

### CROSS REFERENCE TO RELATED APPLICATIONS

This is a Continuation Application of PCT Application No. PCT/JP2006/316277, filed Aug. 14, 2006, which was not published under PCT Article 21(2) in English.

This application is based upon and claims the benefit of priority from prior Japanese Patent Application No. 2005-317681, filed Oct. 31, 2005, the entire contents of which are incorporated herein by reference.

### BACKGROUND OF THE INVENTION

1. Field of the Invention

The present invention relates to a wireless transmitter using an orthogonal frequency division multiplexing (OFDM), a signal to subcarrier allocation method for synchronizing symbols and a wireless receiver.

2. Description of the Related Art

In a wireless transmitter, which transmits signals by multiplexing them by OFDM, a synchronizing symbol used for performing timing synchronization and frequency synchronization is transmitted as one of an OFDM symbol. The timing synchronization is a process for synchronizing symbol timings between the transmitter side and the receiver side. The frequency synchronization is a process for synchronizing carrier frequencies between the transmitter side and the receiver side. The synchronizing symbol is also referred to as an OFDM training symbol.

In IEEE Std 802.11a-1999 (supplement to IEEE Std 802.11-1999), p.12, 17.3.3 PLCP preamble (SYNC), FIG. 110-OFDM training structure, it is described that a signal is allocated steadily to a ±N*k (N: integral number not less than 2, k=1, 2, . . . ) th subcarrier of an OFDM training symbol and null is allocated to other subcarriers. In the time waveform converted from the OFDM training symbol by using an inverse fast Fourier transformation (IFFT) the same waveform is repeated N times. Such a repeating waveform is known to be an effective signal to achieve symbol timing synchronization and carrier frequency synchronization.

Since the above OFDM training symbol allocates the signal only to the ±N*k (N: integral number not less than 2, k=1, 2, . . . ) th subcarrier, subcarriers of approximately 1-(1/N) of the total number of subcarriers included in one OFDM symbol are not used. For example, if N is 2, approximately 50% of the total number of subcarriers remains unused. If N is 4, approximately 75% of the total number of subcarriers remains unused. In other words, utilization efficiency of the subcarriers in the OFDM training symbol is low.

### BRIEF SUMMARY OF THE INVENTION

According to an aspect of the present invention, a wireless transmitter for transmitting a signal of an orthogonal frequency division multiplexing (OFDM) symbol comprising a first generator to generate a plurality of first signals each including a stationary signal; a second generator to generate a plurality of second signals whose total power is less than that of the first signals; an allocation unit configured to allocate the first signals to the ±N*k (N: an integral number not less than or equal to 2, k=1, 2, . . . ) th first subcarriers of a synchronizing symbol and to allocate the second signals to at least some second subcarriers of the synchronizing symbol, the some second subcarriers excluding a center subcarrier; a generating unit configured to transmit a signal of an OFDM symbol including the synchronizing symbol in which the first signals and the second signals are allocated into the first subcarriers and the second subcarriers; and a transmission unit configured to transmit the signal of the OFDM symbol.

### BRIEF DESCRIPTION OF THE SEVERAL VIEWS OF THE DRAWING

FIG. 1 is a block diagram of a wireless transmitter according to one embodiment.

FIG. 2 is a diagram illustrating a basic example of a first allocation method related to a signal to subcarrier allocation for a synchronizing symbol.

FIG. 3 is a diagram showing another basic example of the first allocation method.

FIG. 4 is a diagram showing another basic example of the first allocation method.

FIG. 5 is a block diagram of a wireless receiver according to one embodiment.

FIG. 6 is a block diagram showing the wireless transmitter in FIG. 1 more specifically.

FIG. 7 is a diagram showing a specific example of the first allocation method.

FIG. 8 is a diagram showing a specific example of the first allocation method.

FIG. 9 is a diagram showing a specific example of the first allocation method.

FIG. 10 is a diagram showing a specific example of the first allocation method.

FIG. 11 is a diagram showing a specific example of the first allocation method.

FIG. 12 is a diagram showing a specific example of the first allocation method.

FIG. 13 is a diagram showing a specific example of the first allocation method.

FIG. 14 is a diagram showing a specific example of the first allocation method.

FIG. 15 is a diagram showing a specific example of the first allocation method.

FIG. 16 is a diagram showing a specific example of the first allocation method.

FIG. 17 is a diagram showing a basic example of a second allocation method related to a signal to subcarrier allocation for a synchronizing symbol.

FIG. 18 is a diagram showing another basic example of the second allocation method.

FIG. 19 is a diagram showing another basic example of the second allocation method.

FIG. 20 is a diagram showing a specific example of the second allocation method.

FIG. 21 is a diagram showing a specific example of the second allocation method.

FIG. 22 is a diagram showing a specific example of the second allocation method.

FIG. 23 is a diagram showing a specific example of the second allocation method.

FIG. 24 is a diagram showing a specific example of the second allocation method.

FIG. 25 is a diagram showing a basic example of a third allocation method related to a signal to subcarrier allocation for a synchronizing symbol.

FIG. 26 is a diagram showing another basic example of the third allocation method.

FIG. 27 is a diagram showing a specific example of the third allocation method.

FIG. 28 is a diagram showing a specific example of the third allocation method.

FIG. 29 is a diagram showing a specific example of the third allocation method.

FIG. 30 is a diagram showing a specific example of the third allocation method.

FIG. 31 is a diagram showing a specific example of the third allocation method.

FIG. 32 is a diagram showing a specific example of the third allocation method.

FIG. 33 is a block diagram of a wireless transmitter according to a modified example of FIG. 1.

FIG. 34 is a block diagram of a wireless receiver according to another embodiment.

FIG. 35 is a diagram showing a first example of a frame structure comprising a synchronizing symbol.

FIG. 36 is a flow chart showing an example of a receiving sequence corresponding to the frame structure of FIG. 35.

FIG. 37 is a diagram showing a modified example of the first example of the frame structure comprising the synchronizing symbol.

FIG. 38 is a diagram showing a second example of the frame structure comprising the synchronizing symbol.

FIG. 39 is a flow chart showing an example of a receiving sequence corresponding to the frame structure of FIG. 38.

FIG. 40 is a diagram showing a third example of the frame structure comprising the synchronizing symbol.

FIG. 41 is a flow chart showing an example of a receiving sequence corresponding to the frame structure of FIG. 40.

### DETAILED DESCRIPTION OF THE INVENTION

(Transmitter)

With reference to FIG. 1, in a wireless transmitter according to an embodiment of the present invention, a stationary signal generator 101 and a low occurrence signal generator 102 are provided as a signal source of a signal to be transmitted. A stationary signal generated by the stationary signal generator 101 and a low occurrence signal generated by the low occurrence signal generator 102 are input to a signal to subcarrier allocation unit 103. The signal to subcarrier allocation unit 103 carries out a signal to subcarrier allocation in accordance with an allocation scheme to be explained latter in order to generate an OFDM symbol.

The OFDM symbol output from the signal to subcarrier allocation unit 103 is converted into a time domain signal by an inverse fast Fourier transformation (IFFT) unit 104. The time domain signal is converted into a serial signal by a parallel to serial converter 105. The output signal from the parallel to serial converter 105 is sent to a GI adding unit 106 to add a guard interval and then converted into a baseband analogue signal by a digital to analog converter (DAC) 107. The baseband analogue signal is converted into an analogue signal of a carrier frequency band by a wireless unit 108 and is supplied to an antenna 109 after further undergoing power amplification. Hereby, an OFDM signal is transmitted from the antenna 109.

When the signal to subcarrier allocation unit 103 generates, among the OFDM symbols, a synchronizing symbol (also referred to as an OFDM training symbol) for particularly performing a timing synchronization and a frequency synchronization, a signal is allocated to each subcarrier of the synchronizing symbol as follows. More specifically, first signals are allocated to the ±N*k (N: an integral number not less than 2, k=1, 2, . . . ) th subcarriers (first subcarriers) of the synchronizing symbol and second signals are allocated to the subcarriers (second subcarriers) other than the ±N*k th subcarriers of the synchronizing symbol. The allocation of the first signals to the first subcarriers and the allocation of the second signals to the second subcarriers are fixed so that the total power of the signals allocated to the second subcarriers is smaller than that allocated to the first subcarriers. Generally, in OFDM, a signal is not allocated to a center (0th) subcarrier. Therefore, the signal will not be allocated to the center subcarrier in the present embodiment correspondingly.

In a synchronizing symbol, the above signal to subcarrier allocation may improve utilization efficiency of the subcarriers while maintaining a repeating waveform effective for processing a timing synchronization and frequency synchronization as will be explained below.

(First Allocation Scheme)

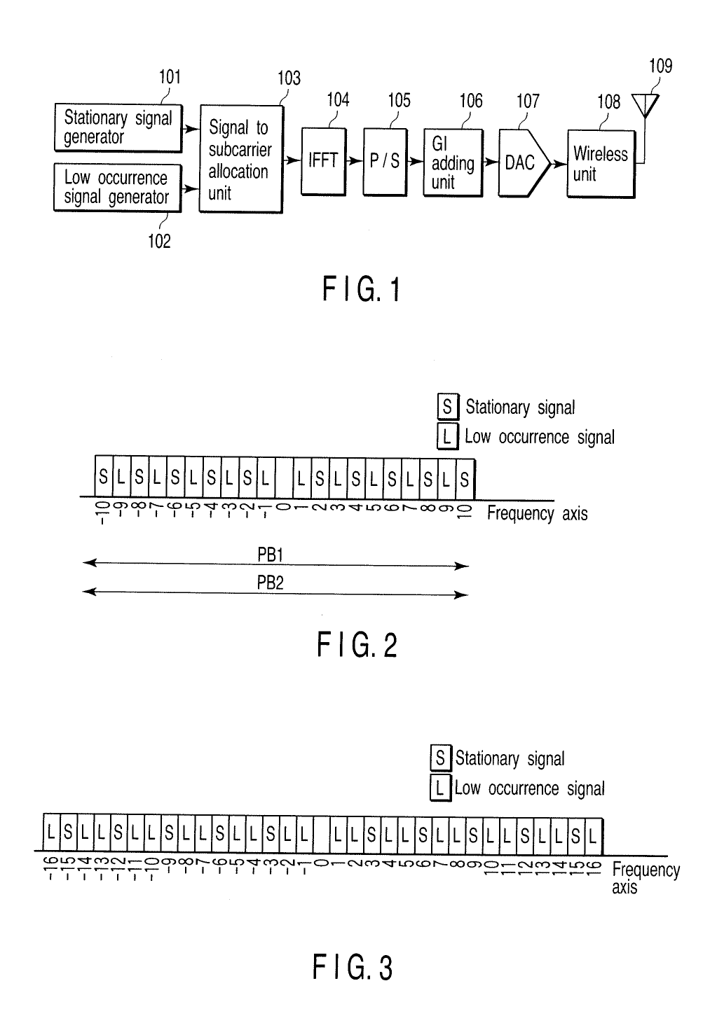

First, a first allocation scheme carried out by the signal to subcarrier allocation unit 103 will be explained. FIGS. 2 to 4 show basic examples of the first allocation scheme. In the first allocation scheme, basically, stationary signals S are used as the first signals to be allocated to the ±N*k th first subcarriers, and low occurrence signals L are used as the second signals to be allocated to the second subcarriers, which are other than the ±N*k th subcarriers. Here, a signal possessing a power value of some kind is constantly allocated to the ±N*k th first subcarriers. The low occurrence signal is a non-stationary signal, i.e., a signal with low occurrence frequency. If no signal occurs, null is allocated to the subcarrier.

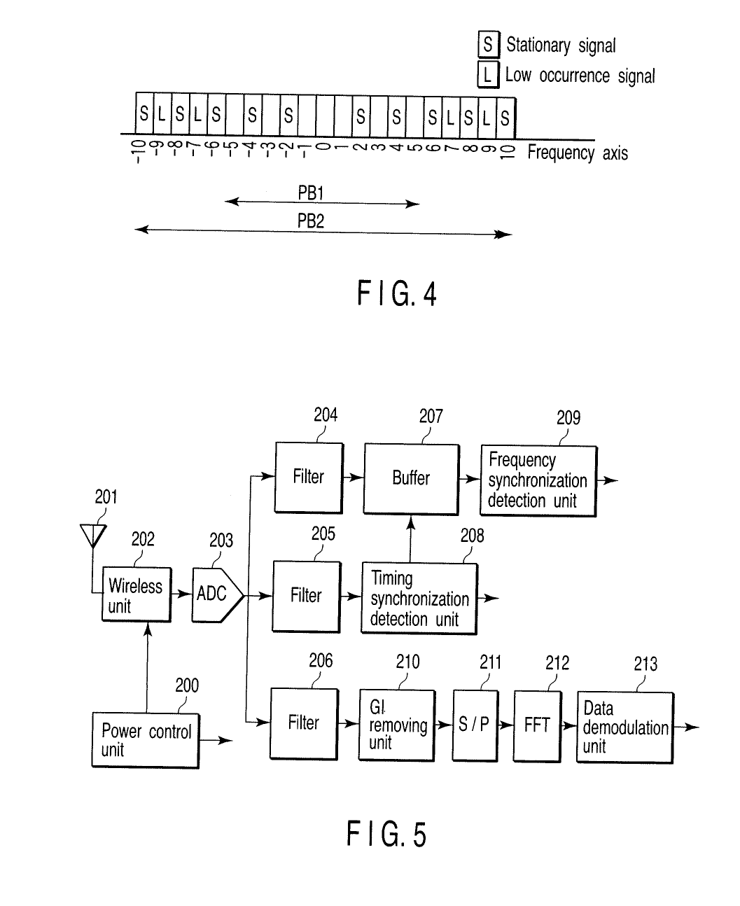

FIGS. 2 and 4 show examples of N=2, and FIG. 3 shows an example of N=3. As shown in FIGS. 2 to 4, each subcarrier is numbered in ascending order in directions of increasing and decreasing frequencies with respect to the center frequency (0) of an OFDM bandpass on a frequency axis. The OFDM bandpass is a frequency band of all subcarriers, which comprises an OFDM symbol. Since the subcarrier of the center frequency of the OFDM bandpass is not used in practice, it shall not be considered in particular in what follows. The effective number of subcarriers within the OFDM symbol (synchronizing symbol) is 20 in FIGS. 2 and 4, and 32 in FIG. 3. However, in a system in which a base station covers a cell radius of several km, the number of subcarriers may become extremely large, such as 1,000 or more.

In the examples of FIGS. 2 and 3, the stationary signals S are allocated to all of the first subcarriers, and the low occurrence signals L are allocated to all of the second subcarriers. In the example of FIG. 4, the stationary signals S are allocated to all of the first subcarriers, and the low occurrence signals L are allocated to some of the second subcarriers. A paging signal or random access signal may be cited as examples of the low occurrence signal L. Nulls are inserted in some of the second subcarriers, where the low occurrence signal L to be allocated has not actually occurred. In the case where the low occurrence signals L to be allocated to all of the second subcarriers have not occurred, nulls are allocated to all of the second subcarriers. Accordingly, the synchronizing symbol generated hereby identifies with the OFDM training symbol disclosed in, for example, IEEE Std 802.11a-1999 (supplement to IEEE Std 802.11-1999), p.12, 17.3.3 PLCP preamble (SYNC), FIG. 110-OFDM training structure introduced above.

According to the examples of FIGS. 2 and 3 where the low occurrence signal L is allocated to all of the second subcarriers, in any partial bandpass within the OFDM bandpass, it is probable that the total power of the signals allocated to the second subcarriers becomes smaller than that allocated to the first subcarriers. As a result, a time waveform of the synchronizing symbol (a waveform obtained by converting the synchronizing symbol to a time domain signal by IFFT) becomes a repeating waveform. In other words, the time waveform of the synchronizing symbol becomes a repeating waveform regardless of the receiving bandpass of a receiver. In addition, since the low occurrence signals L are allocated to all of the second subcarriers in the synchronizing symbols of FIGS. 2 and 3, compared to a conventional scheme in which nulls are allocated to all of the second subcarriers, utilization efficiency of the subcarriers is improved.

On the other hand, in the example of FIG. 4 in which the low occurrence signals L are allocated to some of the second subcarriers, although the subcarrier utilization efficiency somewhat declines compared to the example of FIG. 2, it possesses a high subcarrier utilization efficiency in comparison to the conventional scheme. Moreover, by limiting the frequency band using a filter and receiving it at the receiving side, a repeating waveform with higher accuracy than in the example of FIG. 2 can be received. Specifically, the repeating waveform can be obtained by carrying out band limiting of the receiving signal using, for example, a filter whose pass band is a bandpass from the −5th subcarrier to the 5th subcarrier where the low occurrence signals L are not allocated among the second subcarriers in FIG. 4.

(Receiver)

FIG. 5 shows a structure of the receiving side (receiver) corresponding to the transmission side (transmitter) of FIG. 1. The signal received by an antenna 201 is amplified and converted into a baseband analogue signal by a wireless unit 202. The baseband analogue signal is converted into a baseband digital signal by an analogue to digital converter (ADC) 203. The baseband digital signal undergoes filtering, i.e., band limiting, by filters 204, 205 and 206.

The output signal from the filter 206 is converted into a parallel signal by a serial to parallel converter (S/P) 211 after a guard interval is removed by a GI removing unit 210. The output signal from the serial to parallel converter 211 is converted into a signal of a frequency domain by using a fast Fourier transformation (FFT) unit 212 and input to a data demodulation unit 213. The data demodulation unit 213 demodulates the signal in order to reproduce the data transmitted by the OFDM signal.

Meanwhile, the output signals from the filters 205 and 206 are input to synchronizing processing units described below. That is, the output signal from the filter 205 is input to a timing synchronization detection unit 208. The timing synchronization detection unit 208 detects symbol timing by using the signal of a synchronizing symbol, i.e., the signal input from the filter 205 during a synchronizing symbol period. Specifically, the timing synchronization detection unit 208 obtains a correlation value between the repeating waveforms of the synchronizing symbols and detects the symbol timing by using the correlation value's peak position. When a known signal is included in the synchronizing symbol, the symbol timing can also be detected by using the output of a matched filter using the known signal.

The symbol timing detected by the timing synchronization detection unit 208 is given to a buffer 207 and a frequency synchronization detection unit 209. The buffer 207 initiates data buffering along with the initiation of timing synchronization. The output signal from the filter 204 is input to the buffer 207. The buffer 207 buffers data of a past certain period of the input signal received from the filter 204. The certain period may be, for example, a synchronizing symbol length or a time slightly longer than the synchronizing symbol length in order to allow time for, such as, processing delay.

While data renewal within the buffer 207 is suspended at the symbol timing detected by the timing synchronization detection unit 208, the synchronizing symbol is extracted from the data accumulated in the buffer 207 and input to the frequency synchronization detection unit 209. The frequency synchronization detection unit 209 detects an offset of a carrier frequency (estimates frequency offset amount) by using the synchronizing symbol input from the buffer 207. Specifically, the frequency synchronization detection unit 209 extracts the repeating waveform from the synchronizing symbol and estimates the carrier frequency offset amount by taking the correlation between the repeating waveforms.

Further, the symbol timing detected by the timing synchronization detection unit 208 and the offset information of the carrier frequency detected by the frequency synchronization detection unit 209 are supplied to each unit, which is unshown.

Next, pass band PB1 of the filter 204 and pass band PB2 of the filter 205 will be explained. In the frequency synchronization detection unit 209, the repeating waveform is necessary as an input signal. On the other hand, in the timing synchronization detection unit 208, if a known signal is inserted, the repeating waveform is not indispensable.

If the received synchronizing symbol is a synchronizing symbol generated by the allocation scheme shown in FIG. 2, the repeating waveform can be obtained in any bandpass. Accordingly, the pass band PB1 of the filter 204 inserted in the input side of the frequency synchronization detection unit 209 and the pass band PB2 of the filter 205 inserted in the input side of the timing synchronization detection unit 208 can both be a bandpass which extends over the entire symbol of the synchronizing symbol as shown in FIG. 2.

Correspondingly, if a received synchronizing symbol is a synchronizing symbol generated by the allocation scheme shown in FIG. 4, in order to generate a highly accurate repeating waveform, it is necessary to cut out only the center bandpass of the signal of the synchronizing symbol. Since the repeating waveform is necessary in the frequency synchronization detection unit 209, the pass band PB1 of the filter 204 should be set to a bandpass limited to the vicinity of the center frequency of the OFDM bandpass as shown in FIG. 4. Even when a received synchronizing symbol is a synchronizing symbol generated by the allocation method shown in FIG. 4, if the accuracy of the repeating waveform needs only to be at the same level as the case shown in FIG. 2, the bandpass shown in FIG. 2 can be used.

The filters 204 and 205 may share one filter, if, for example, they have identical characteristics in which the pass bands PB1 and PB2 are the same as shown in FIG. 2. The filters 204 and 205 can be omitted if a bandpass extending over the entire signal of the synchronizing symbol is used for the timing synchronization detection unit 208 and the frequency synchronization detection unit 209. A power control unit 200 is arranged to control on/off of the power of the wireless unit 202 and a part of a digital section.

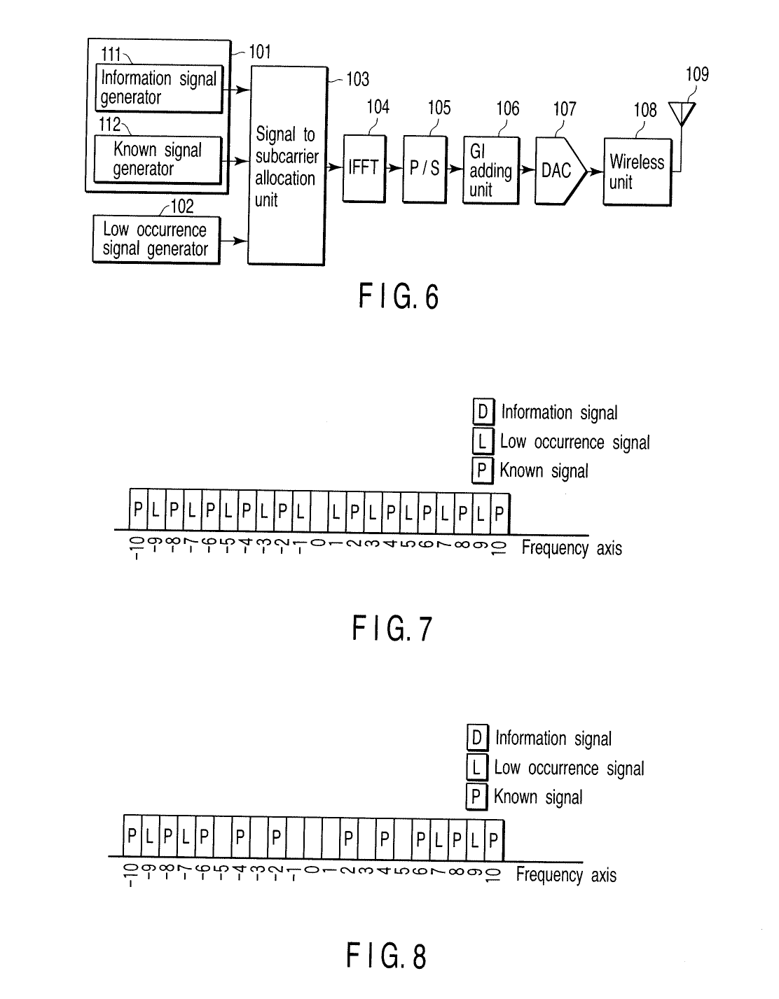

FIG. 6 shows a further specified version of the transmitter in FIG. 1. As shown in FIG. 6, the stationary signal generator 101 comprises an information signal generator 111 and a known signal generator 112. The stationary signals S in FIGS. 2 to 4 are divided in two in accordance with whether it is known information for the receiving side. In other words, the stationary signal is called the known signal if its information is known, and the information signal if its information is unknown. The information signal is generated by the information signal generator 111, and the known signal is generated by the known signal generator 112.

(Specified Examples of a First Allocation Scheme)

The following explains specified examples of a first allocation scheme. FIGS. 7 to 16 show examples of a signal to subcarrier allocation for a synchronizing symbol in the case where the stationary signals S in FIG. 2 or FIG. 4 are sorted into a known signal P and an information signal D when N=2. The known signal P is generated by the known signal generator 112 in FIG. 6, and the information signal D is generated by the information signal generator 111 in FIG. 6.

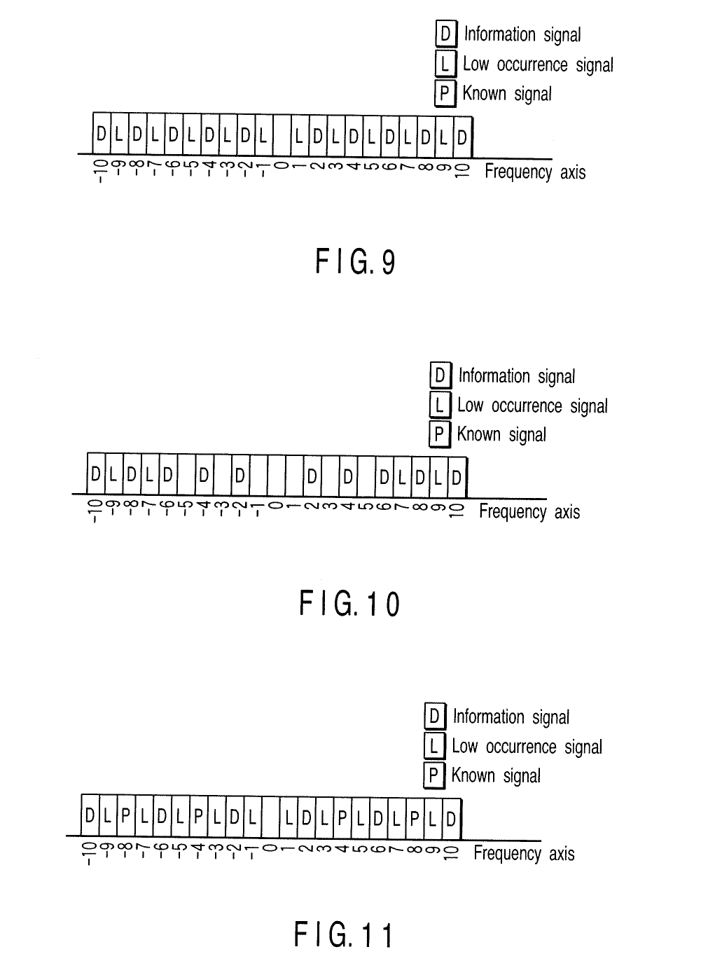

FIGS. 7 and 8 are specified examples of FIGS. 2 and 4 respectively and regard all stationary signals allocated to the ±N*k th first subcarriers as the known signal P. Similarly, FIGS. 9 and 10 are specified examples of FIGS. 2 and 4 respectively and regard all stationary signals allocated to the ±N*k th first subcarriers as the information signal D.

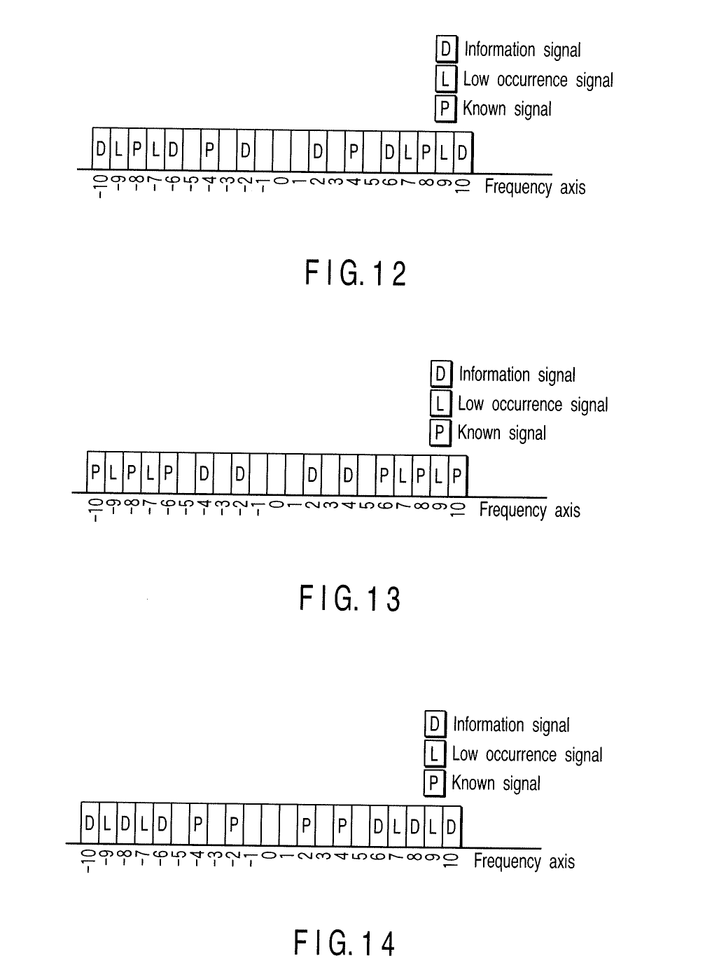

Similarly, FIGS. 11 and 12 are specified examples of FIGS. 2 and 4 respectively and regard some of the stationary signals allocated to the ±N*k th first subcarriers as the known signals P and some of the rest as the information signals D.

FIGS. 13 to 16 show other specified examples of FIG. 4. In FIG. 13, among the stationary signals allocated to the first subcarriers, the stationary signals adjacent to the second subcarriers, to which the low occurrence signals L are not allocated, are regarded as the information signals D and the rest of the stationary signals are regarded as the known signals P.

In FIG. 14, among the stationary signals allocated to the first subcarriers, the stationary signals of the subcarrier adjacent to the second subcarriers, to which the low occurrence signals L are not allocated, are set as the known signals P and the rest of the stationary signals are regarded as the information signals D.

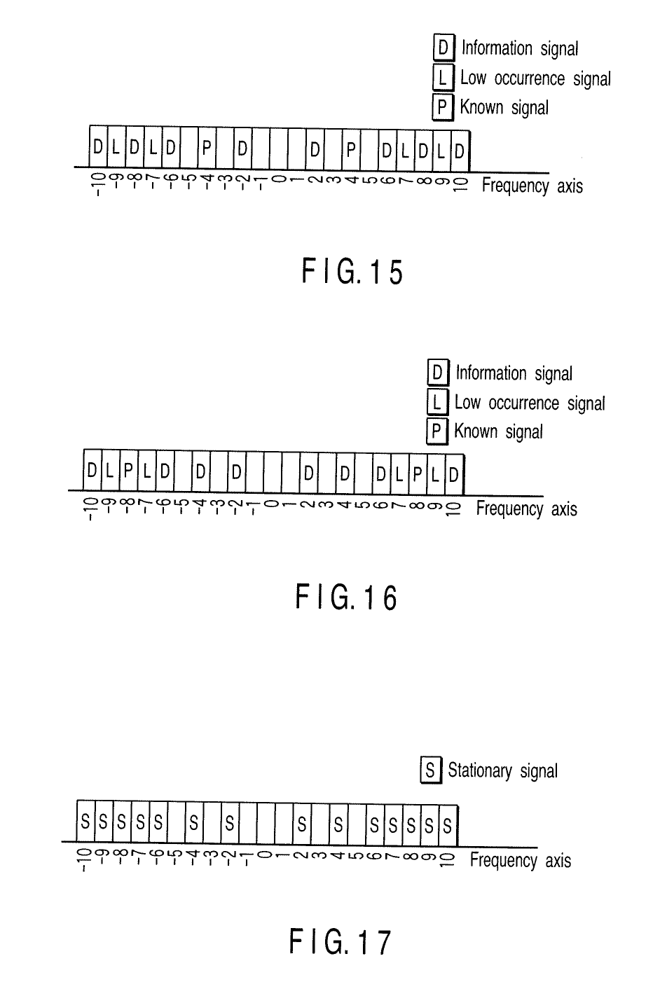

In FIG. 15, among the stationary signals allocated to the first subcarriers, some of the stationary signals adjacent to the second subcarriers, to which the low occurrence signals L are not allocated, are regarded as the known signals P and the rest of the stationary signals are regarded as the information signals D.

In FIG. 16, among the stationary signals allocated to the first subcarriers, some of the stationary signals unadjacent to the second subcarriers, to which the low occurrence signals L are not allocated, are regarded as the known signals P and the rest of the stationary signals are regarded as the information signals D.

(Second Allocation Scheme)

Next, a second allocation scheme at the signal to subcarrier allocation unit 103 will be explained. FIGS. 17 to 19 show basic examples of the second allocation scheme. In the second allocation scheme, basically, stationary signals S are used as first signals to be allocated to the ±N*k th first subcarriers as well as second signals to be allocated to second subcarriers, which are other than the ±N*k th subcarriers. However, in the second allocation scheme, the stationary signals S are always allocated to only some of the second subcarriers.

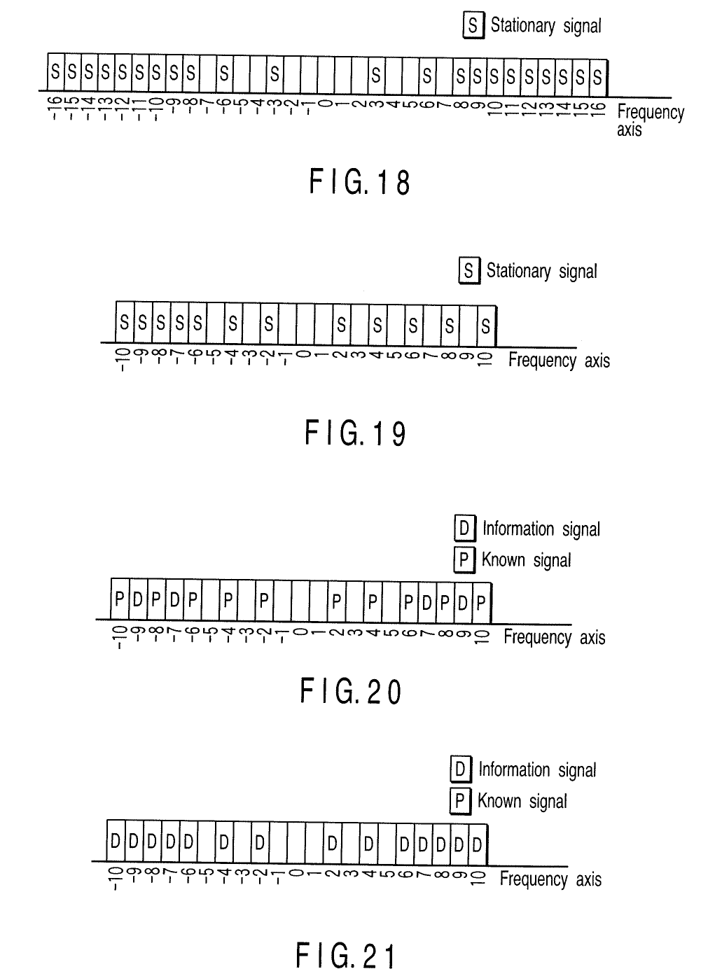

FIGS. 17 and 18 show examples of N=2 and N=4 respectively. The stationary signals S are allocated to the outer domain of an OFDM bandpass, i.e., only to subcarriers having a subcarrier number whose absolute value is larger than a certain value. FIG. 19 is another example of N=2 in which the stationary signals S are allocated to a part of a continuous domain of the second subcarriers. Here, “a certain value” is, for example, a value predetermined by a system. When a system supports a plurality of bandwidths, a subcarrier number corresponding to any one of the bandwidth, which is not the largest among the plurality of bandwidths, can be used as a certain value. The same will follow.

According to the examples of FIG. 17 to 19, by cutting out the partial bandpass of the OFDM bandpass using a filter, the total power of the signals to be allocated to the second subcarriers becomes smaller than that to be allocated to the first subcarriers whereby a time waveform of the synchronizing symbol becomes a repeating waveform. For instance, in the example of FIG. 17, the repeating waveform can be obtained by band limiting the signals using a filter whose pass band is a bandpass from the −5th subcarrier to the 5th subcarrier at the receiving side. In the example of FIG. 19, the repeating waveform can be obtained by band limiting the signals using a filter whose pass band is a bandpass rightwards from the −5th subcarrier.

Further, in FIGS. 17 to 19, since the low occurrence signal L is allocated to some of the second subcarriers, utilization efficiency of the subcarrier is improved in comparison to the case where null is allocated to all of the second subcarriers.

(Specific Examples of the Second Allocation Scheme)

FIGS. 20 to 24 show a signal to subcarrier allocation for a synchronizing symbol in the case where the stationary signals S in FIG. 17 or FIG. 19 are sorted into a known signal P and an information signal D when N=2. The known signal P is generated by the known signal generator 112 in FIG. 6, and the information signal D is generated by the information signal generator 111 in FIG. 6.

In FIG. 20, the known signals P are stationary signals allocated to the first subcarriers, and the information signals D are stationary signals allocated to some of the second subcarriers.

In FIG. 21, all stationary signals, i.e., stationary signals allocated to the first subcarriers and stationary signals allocated to some of the second subcarriers are regarded as the information signals D.

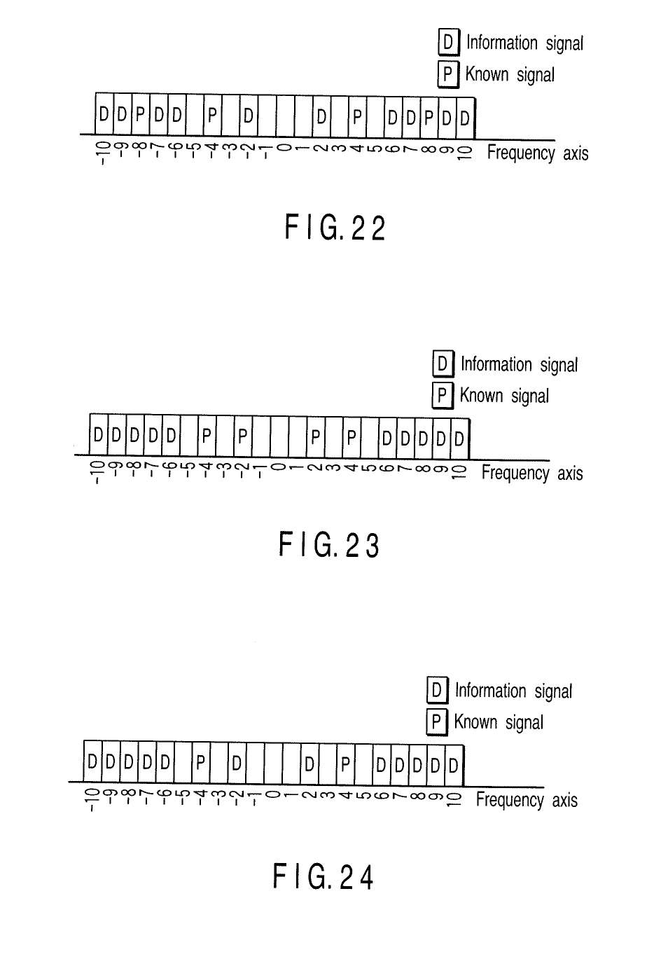

In FIG. 22, among the stationary signals allocated to the first subcarriers, some of them are regarded as the known signals P. Other stationary signals, i.e., some of the other stationary signals allocated to the first subcarriers and the stationary signals allocated to some of the second subcarriers are regarded as the information signals D.

In FIG. 23, among the stationary signals allocated to the first subcarriers, the stationary signals particularly allocated to the inner domain of the OFDM bandpass, i.e., stationary signals of subcarriers having a subcarrier number whose absolute value is smaller than a certain value are regarded as the known signal P. The rest of the stationary signals, i.e., some of the other stationary signals allocated to the first subcarriers and the stationary signals allocated to some of the second subcarriers are regarded as the information signal D.

In FIG. 24, among the stationary signals allocated to the first subcarriers, stationary signals in the inner domain of the OFDM bandpass, i.e., some of the stationary signals of subcarriers having a subcarrier number whose absolute value is smaller than a certain value are regarded as the known signals P, and the rest of the stationary signals, i.e., some of the other stationary signals allocated to the first subcarriers and the stationary signals allocated to some of the second subcarrier are regarded as the information signals D.

(Third Allocation Scheme)

Next, a third allocation scheme at the signal to subcarrier allocation unit 103 will be explained. In the third allocation scheme, stationary signals S are allocated to all of the ±N*k (N: an integer not less than 2, k=1, 2, . . . ) th first subcarriers as well as to some of the other second subcarriers. Furthermore, a low occurrence signal L is allocated to some or all of the remaining second subcarriers.

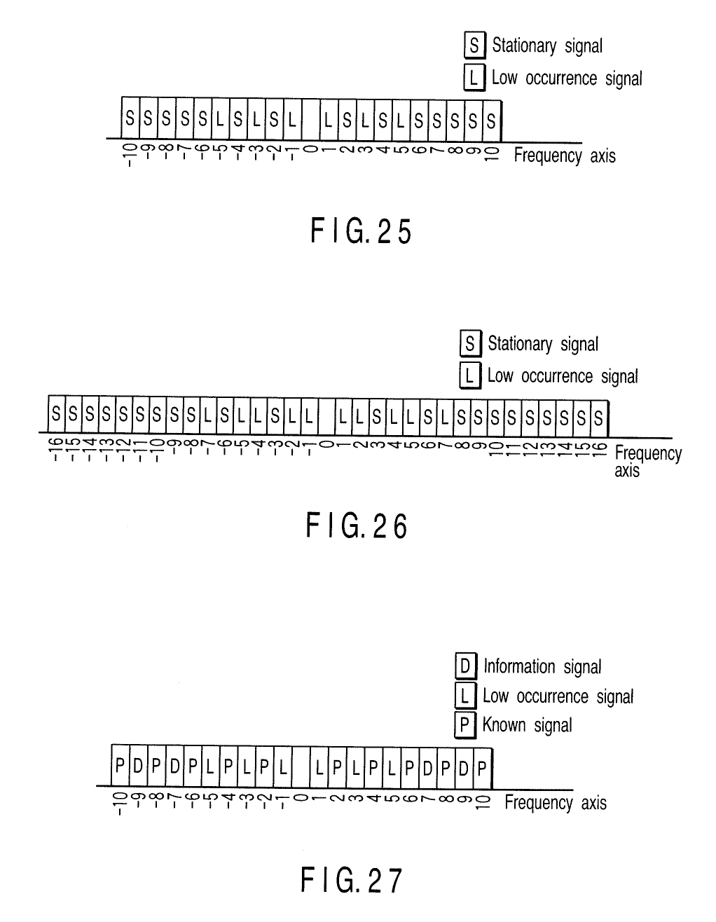

FIGS. 25 and 26 show basic examples of the third allocation scheme where N=2 and N=3 respectively. In the examples of FIGS. 25 and 26, among the second subcarriers, the stationary signal S is allocated to the outer domain of the OFDM bandpass, i.e., to some of the subcarriers having a subcarrier number whose absolute value is larger than a certain value, and the low occurrence signal L is allocated to the remaining inner domain, i.e., subcarriers having a subcarrier number whose absolute value is smaller than a certain value.

According to the examples of FIGS. 25 and 26, likewise the first and second allocation schemes, in any partial bandpass of the OFDM bandpass, it is probable that total power of the signals allocated to the second subcarriers becomes smaller than that allocated to the first subcarriers. As a result, the time waveform of the synchronizing symbol becomes a repeating waveform. In addition, in the examples of FIGS. 25 and 26, by band limiting a signal using a filter whose pass band is the inner bandpass of the OFDM bandpass where the low occurrence signals L are allocated, a repeating waveform with higher accuracy than in the case of receiving the whole bandpass can be obtained at the receiving side.

Further, in FIGS. 25 and 26, since the stationary signals S or low occurrence signals L are allocated to all of the second subcarriers, utilization efficiency of the subcarriers is improved in comparison to the case of allocating nulls to all of the second subcarriers.

(Specific Example of the Third Allocation Scheme)

FIGS. 27 to 32 show the signal to subcarrier allocation for a synchronizing symbol in the case where the stationary signals S in FIG. 25 are sorted into the known signal P and information signal D when N=2. The known signals P are generated by the known signal generator 112 in FIG. 6, and the information signals D are generated by the information signal generator 111 in FIG. 6.

In the example of FIG. 27, the stationary signals allocated to the ±N*k th first subcarriers are the known signals P and the stationary signals allocated to the other second subcarriers are the information signals D.

In FIG. 28, all stationary signals allocated to the first and second subcarriers are the information signals D.

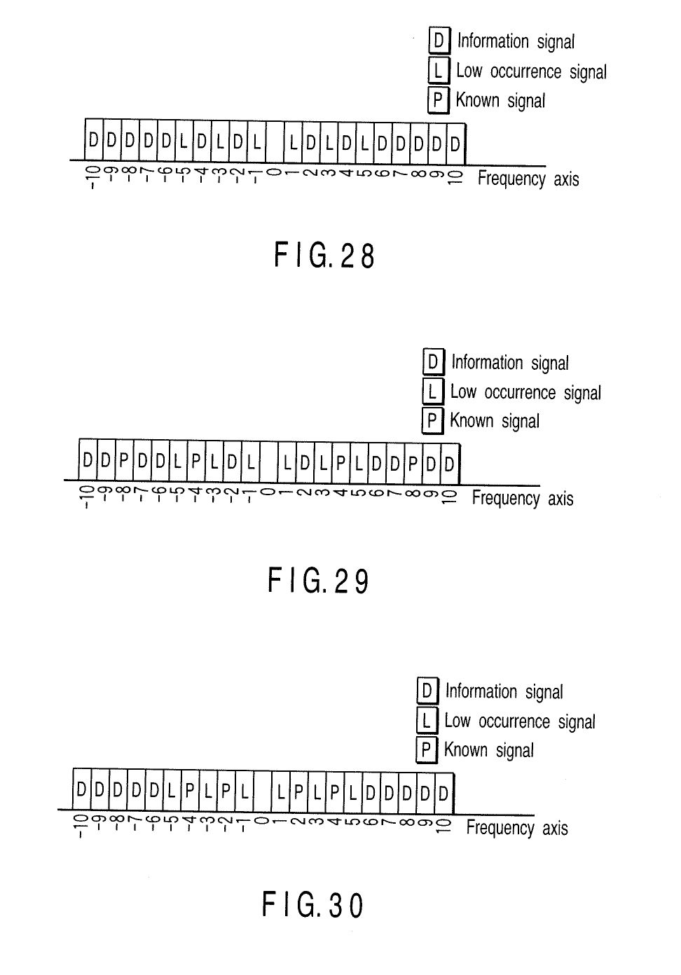

In FIG. 29, some of the stationary signals allocated to the first subcarriers are the known signals P, and the other stationary signals, i.e., stationary signals allocated to subcarriers of the first subcarriers that the known signals P are not allocated, and the stationary signals allocated to the second subcarriers are the information signals D.

In FIG. 30, among the stationary signals allocated to the first subcarriers, the signals adjacent to the low occurrence signals L allocated to the second subcarriers are the known signals P, and the rest of the stationary signals are the information signals D.

In FIG. 31, among the stationary signals allocated to the first subcarriers, some of the signals adjacent to the low occurrence signals L allocated to the second subcarriers are the known signals P, and the rest of the stationary signals are the information signals D.

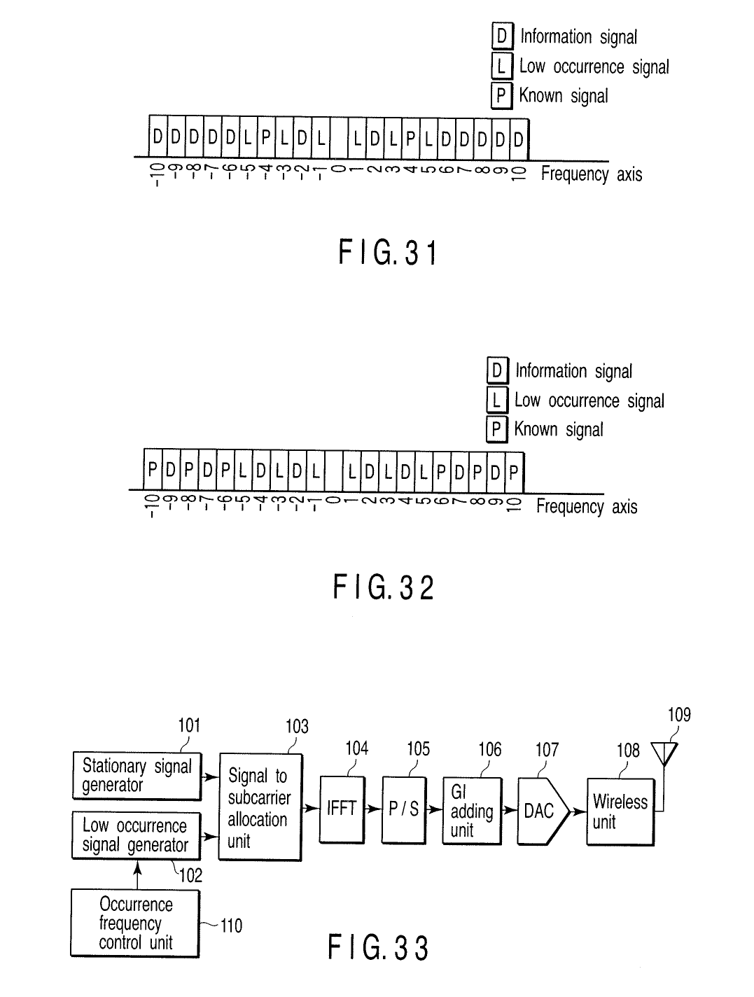

In FIG. 32, among the stationary signals allocated to the first subcarriers, the signals not adjacent to the low occurrence signals L allocated to the second subcarriers are the known signals P, and the rest of the signals are the information signals D.

FIG. 33 shows a modified example of the transmitter in FIG. 1, to which an occurrence frequency control unit 110 is added to the FIG. 1 transmitter. In the examples of signal to subcarrier allocation shown in FIGS. 2 to 4, 7 to 16, and 25 to 32, the low occurrence signals L are inserted in some or all of the second subcarriers excluding the ±N*k th subcarriers.

In the synchronizing symbol in which the low occurrence signals L are allocated to some or all of the second subcarriers as mentioned, the occurrence frequency control unit 110 controls the occurrence frequency of the low occurrence signal L generated by the low occurrence generator 102 so that it becomes less than a certain threshold value. In other words, a threshold value that gives the upper limit of the occurrence frequency of the low occurrence signal is supplied from the occurrence frequency control unit 110 to the low occurrence signal generator 102, which then generates the low occurrence signal according to the occurrence frequency controlled to become smaller than the given threshold value.

The threshold value provided by the occurrence frequency control unit 110 is calculated based on roughly the following two standards. As the first standard, the ratio between the number of subcarriers of the ±N*k th first subcarriers, to which signal are allocated and the number of subcarriers of the second subcarriers excluding the ±N*k th subcarrier, to which signals are allocated, is used. For instance, in the example of FIG. 2, the number of first subcarriers equals the number of second subcarriers, i.e., the ratio above is 1. Thereby, the occurrence frequency control unit 110 determines the threshold value as 1 and controls the occurrence frequency of the low occurrence signal L so that it becomes less than 1. On the other hand, in the example of FIG. 3, the number of the first subcarriers is about half the number of the second subcarriers, i.e., the ratio above is about 0.5. Accordingly, the occurrence frequency control unit 110 determines the threshold value as approximately 0.5 and controls the occurrence frequency of the low occurrence signal L so that it becomes less than approximately 0.5.

The second standard related to the threshold value provided by the occurrence frequency control unit 110 is a margin for a transmission channel distortion. The first standard explained above shows theoretical limitations. However, in an actual wireless communication environment, transmission signals undergo various distortions called a transmission channel distortion in a transmission channel. In some cases, such distortions may be the cause for the repeating waveform to collapse. For this reason, it is necessary to provide a margin in consideration of such distortion. For instance, in the example of FIG. 2, in a state where there is no transmission channel distortion, the occurrence frequency can be set to less than 1 based on the first standard, however, in consideration of the case in which a transmission channel distortion exists, a margin can be provided with the occurrence frequency of less than 0.3. By limiting the occurrence frequency in such way, the repeating waveform can be properly extracted at the receiving side even when the transmission channel distortion exists.

(Example of a Low Occurrence Signal as a Paging Signal)

The following specifically explains the case where the low occurrence signal L is a paging signal. The paging signal is a signal used when a base station pages a terminal in, for example, a cellular system. Having detected the paging signal, the terminal starts communication assuming that there was a call from the base station.

In the example of the synchronizing symbol possessing the signal to subcarrier allocation as shown in FIG. 2, the subcarrier (second subcarrier) in the odd number position in a sequence is allocated to each user, who detects the paging signal by observing the allocated subcarrier. For example, when the subcarriers in the odd number position in a sequence are allocated respectively to different users, in the example of FIG. 2, paging control can be carried out on 10 users. By allocating two or more subcarriers to each user, accuracy of the paging signal detection can be improved. For instance, by allocating two subcarriers to each user, the example in FIG. 2 allows paging control on 5 users.

By dividing the users connected to the base station in several groups, paging can also be carried out in units of groups. In such case, the signal for group paging shall be called a paging indicator (PI) in order to distinguish from the paging signal. The PI signal shows that there is a call for at least one user belonging to the group. The user is paged by transmitting the paging signal after transmitting the PI signal. In other words, the user initiated by the PI signal can detect whether there has been a call addressed to the user itself by receiving the paging signal following the PI signal. When two subcarriers are allocated to each group of 10 users, in the example of FIG. 2, paging can be carried out on 50 users.

In order to detect a paging signal from the receiving signal at the receiving side, it is necessary to perform a symbol timing synchronization and frequency synchronization by using a synchronizing symbol. If the symbol timing synchronization is not achieved, the synchronizing symbol including the paging signal cannot be located in the receiving signal, and the paging signal cannot be detected. If the frequency synchronization is not achieved, other adjacent subcarrier signals may be detected due to the signal shifting in the frequency direction. When signals, which have achieved symbol timing synchronization and frequency synchronization are subjected to FFT (fast Fourier transform), the signals can be separated accurately for each subcarrier. The paging signal inserted in the subcarrier allocated to the user can be detected from the signal separated for each subcarrier. By observing the allocated subcarrier, the user predicts that there has been a call if a signal power is detected, and that there has been no call if the signal power is not detected.

In order to detect the paging signal as mentioned, the symbol timing synchronization and frequency synchronization are required as a pretreatment. In a general cellular system, the user confirms the paging signal periodically in order to confirm whether there is a call addressed to the user itself. In addition, if there is no call addressed to the user as a result of confirmation, the terminal is put to a dormant state until the next confirmation timing to reduce power consumption. In other words, the shorter the time required for confirming paging signals, the more the power consumption required for confirming calls can be reduced, which, as a result, enables a longer standby time.

The synchronizing symbol mentioned above can include all signals for symbol timing synchronization, frequency synchronization and paging. Accordingly, by only receiving one synchronizing symbol, the detection of each signal for symbol timing synchronization, frequency synchronization and paging can be confirmed. Therefore, in comparison to the method of inserting the signal for synchronization and the signal for paging in a separate OFDM symbol, it has the advantage of being able to reduce the time required for detecting the paging signal.

Explanations on a receiver structure where the low occurrence signal L is a paging signal, a frame structure including the synchronizing symbol and a receiving sequence will follow.

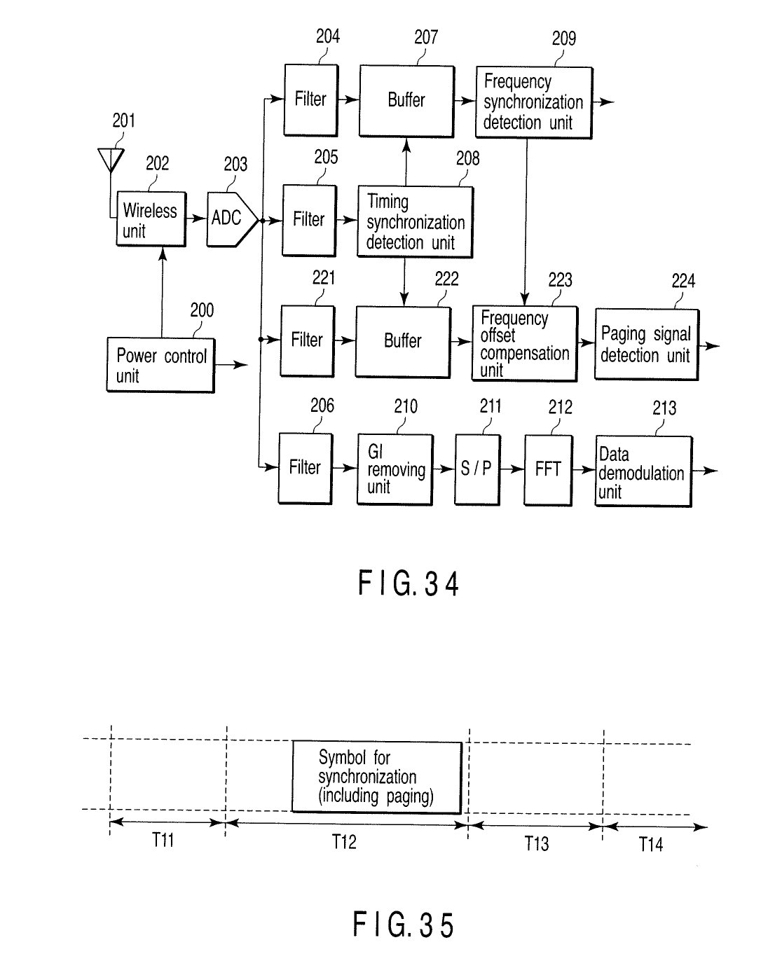

FIG. 34 is an example of a receiver structure where the low occurrence signal L is a paging signal. A filter 221, buffer 222, frequency offset compensation unit 223 and paging signal detection unit 224 are added to the receiver shown in FIG. 5.

A signal received by the antenna 201 is amplified and converted into a baseband analogue signal by the wireless unit 202. The baseband analogue signal is converted into a baseband digital signal by an analogue to digital converter (ADC) 203. The baseband digital signal undergoes filtering by filters 204, 205, 206 and 221.

The output signal from the filter 206 is converted into a parallel signal by a serial to parallel converter (S/P) 211 after a guard interval is removed by a GI removing unit 210. The output signal from the serial to parallel converter 211 is converted into a signal in a frequency domain by a fast Fourier transformation unit (FFT) 212 and is demodulated by a data demodulation unit 213.

The output signal from the filter 205 is input to a timing synchronization detection unit 208, which detects a symbol timing using the signal input from the filter 205 during the synchronizing symbol period. Specifically, the timing synchronization detection unit 208 obtains a correlative value between the repeating waveforms of the synchronizing symbols and detects the symbol timing by using the peak position of the correlative value. When the signal inserted in the synchronizing symbol is a known signal, the symbol timing can also be detected by using the output of a matched filter, which uses the known signal.

The symbol timing detected by the timing synchronization detection unit 208 is given to a buffer 207, frequency synchronization detection unit 209 and buffer 222. At the buffer 207, buffering of data is initiated together with the initiation of the timing synchronization. An output signal from the filter 204 is input to the buffer 207. The buffer 207 buffers data of the past certain fixed period of the input signal from the filter 204. The certain fixed period may be, for example, a synchronizing symbol length or a time slightly longer than the synchronizing symbol length in order to allow time for processing delay and the like.

Data update within the buffer 207 is suspended with the symbol timing detected by the timing synchronization detection unit 208, and, with that, the synchronizing symbol is extracted from the data accumulated in the buffer 207 and input to the frequency synchronization detection unit 209. The frequency synchronization detection unit 209 uses a synchronizing symbol input from the buffer 207 to perform frequency offset (estimation of frequency offset amount). Specifically, the frequency synchronization detection unit 209 extracts the repeating waveform from within the synchronizing symbol and estimates the offset amount of a carrier frequency by taking the correlation between the repeating waveforms. Information of the frequency offset amount obtained in such manner is given to a frequency offset compensation unit 223.

On the other hand, with the initiation of the timing synchronization, the buffer 222 starts the buffering of data and retains data of a certain fixed period of the past. The output signal from the filter 221 is input to the buffer 222. Data update within the buffer 222 is suspended with the symbol timing detected by the timing synchronization detection unit 208, and, with that, the synchronizing symbol is extracted from the data accumulated in the buffer 222 and is input to the frequency offset compensation unit 223. At the frequency offset compensation unit 223, the frequency offset of the synchronizing symbol input from the buffer 222 is compensated using information of the frequency offset amount provided by the frequency synchronization detection unit 209.

The synchronizing symbol whose frequency offset is compensated is input to a paging signal detection unit 224. The paging signal detection unit 224 detects the paging signal from the input synchronizing symbol. In such manner, paging can be detected by detecting the paging signal extracted from a signal having achieved symbol timing synchronization and frequency synchronization.

With regard to the four filters 204 to 206 and 221 shown in FIG. 34, a filter may be shared if they are able to have the same pass band. When band limiting is unnecessary, these filters may be omitted. As for buffers 207 and 222, when the period to retain data is the same, a buffer can be shared. A power control unit 200 is provided to control on/off of the power source of the wireless unit 202 and a part of the digital unit as explained late

(First Frame Structure and Receiving Sequence)

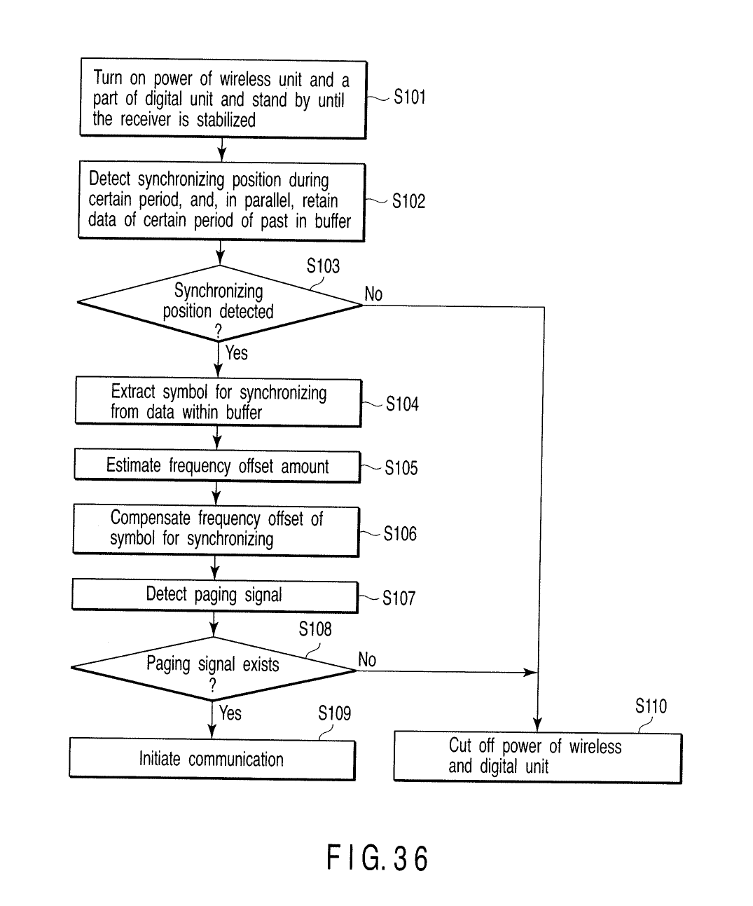

Next, a frame structure and receiving sequence in the case where a low occurrence signal L is a paging signal will be explained using FIGS. 35 and 36. As shown in FIG. 35, a synchronizing symbol in which the low occurrence signal L is a paging signal is inserted arbitrarily into the OFDM signal. Other OFDM symbols are inserted before and after the synchronizing symbol.

Now, the receiving sequence will be explained by using FIG. 36. First, the wireless unit 202 and a part of the digital unit (for instance, components subsequent to ADC 203 in FIG. 34) are powered on and put on standby until the receiver is stabilized (step S101). The process of step S101 is carried out during period T11 in FIG. 35. Generally, a certain time for standby is required in a wireless unit since its performance is unstable immediately after power-on. Especially, the output frequency of a synthesizer, which determines a carrier frequency, fluctuates immediately after power-on. If the symbol timing synchronization and frequency synchronization are carried out in such unstable state, the accuracy of symbol timing synchronization may deteriorate, and further, the carrier frequency may change after the frequency synchronization. Thus, the output frequency of the synthesizer needs to be stabilized prior to initiating the synchronizing process.

Next, a synchronizing position is detected during a fixed period of time T12 in FIG. 35, and, in parallel, data of a certain fixed period of the past is retained at buffers 207 and 222 (step S102). Here, the fixed period of time T12 is set so as to include time before and after when the arrival of the synchronizing symbol is predicted from information obtained beforehand. As a result of step S103, if the synchronizing position (symbol timing) is not detected during the fixed period T12 (when the result of step S103 is NO), the power of the wireless unit 202 and a part of the digital unit is turned off and is put to a dormant state (step S110).

When the symbol timing is detected in step S103 (when the result of step S104 is YES), the process of steps S104 to S107 is carried out during period T13 in FIG. 35. That is, the synchronizing symbol is extracted from the data in buffer 207 on the basis of the synchronizing position (symbol timing) detected in step S103 (step S104). Detection (estimation) of the frequency offset amount is carried out using the extracted synchronizing symbol (step S105). The frequency offset of the synchronizing symbol is compensated using the detected frequency offset amount (step S106), and detection of a paging signal is carried out (step S107).

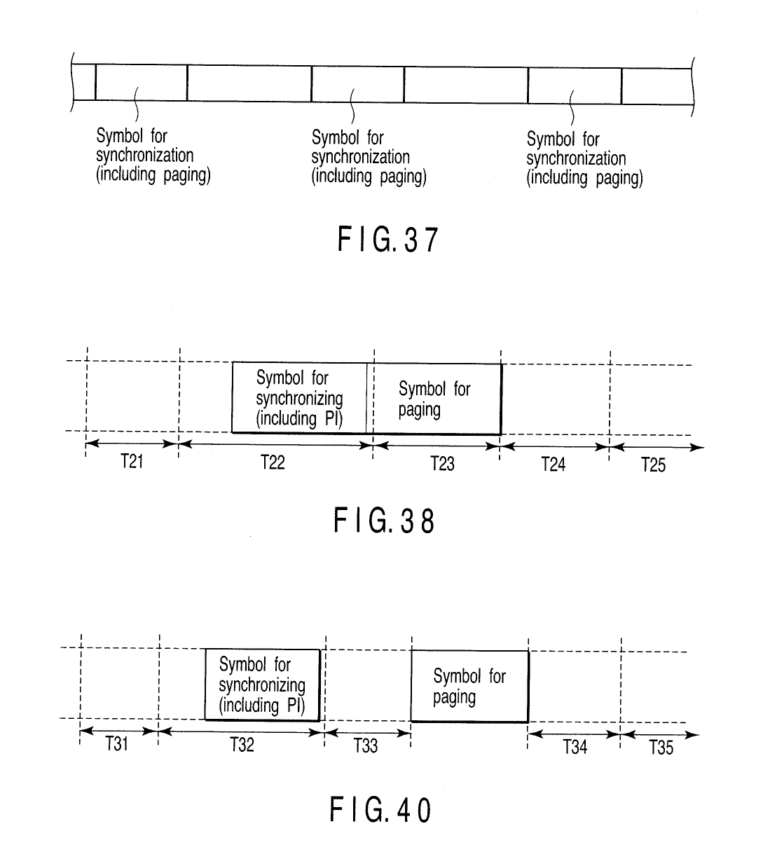

When the paging signal is not detected in step S107 (when the result of step S108 is NO), the power of the wireless unit and a part of the digital unit is turned off and is put to a dormant state (step S110). When the paging signal is detected (the result of step S108 is YES), wireless communication is initiated during period T14 in FIG. 35 (step S109). Meanwhile, the synchronizing symbol may be inserted periodically as shown in FIG. 37.

(Second Frame Structure and Receiving Sequence)

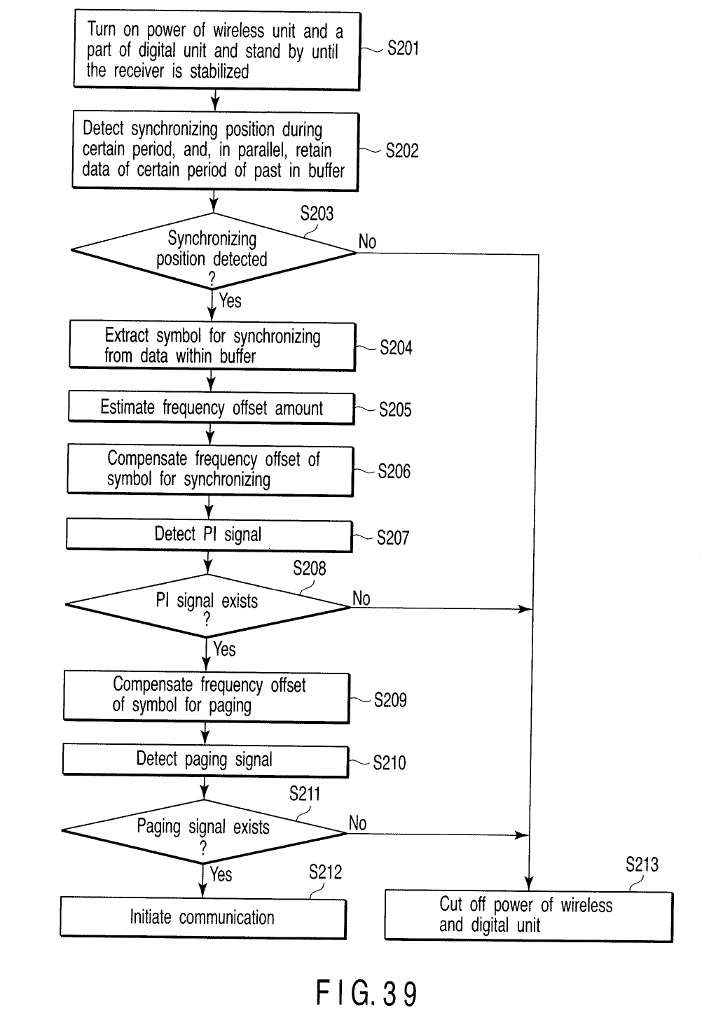

Next, a frame structure and receiving sequence in the case where a low occurrence signal L is a PI signal are explained by using FIGS. 38 and 39. As shown in FIG. 38, a synchronizing symbol in which the low occurrence signal is a PI signal is inserted in the OFDM signal. As explained above, when using a PI signal, a paging signal is required subsequent to the PI signal. Therefore, as shown in FIG. 38, a symbol for paging including a paging signal is inserted immediately after the synchronizing symbol.

Next, the receiving sequence in FIG. 39 will be explained. The process of steps S201 to S206 in FIG. 39 is the same as the process of steps S101 to 106 in FIG. 36. That is, the wireless unit 202 and a part of the digital unit are powered on and put on standby until the receiver is stabilized (step S201). The process of step S201 is carried out during period T21 in FIG. 38. Subsequently, the synchronizing position is detected during a fixed period of time T22 in FIG. 35, and, in parallel, data of a certain fixed period of the past is retained at buffers 207 and 222 (step S202). Here, the fixed period of time T22 is set so as to include time before and after when the arrival of the synchronizing symbol is predicted from information obtained beforehand. As a result of step S203, if the synchronizing position (symbol timing) is not detected during the fixed period of time T22 (when the result of step S203 is NO), the power of the wireless unit 202 and a part of the digital unit is turned off and is put to a dormant state (step S213).

If the symbol timing is detected in step S203 (when the result of step S203 is YES), the process of steps S204 to 207 is carried out during the period T23 in FIG. 35. In other words, the synchronizing symbol is extracted from data within the buffer 207 on the basis of the synchronizing position (symbol timing) detected in step S203 (step S204). Detection (estimation) of the frequency offset amount is carried out using the extracted synchronizing symbol (step S205). Frequency offset of the synchronizing symbol is compensated by using the detected frequency offset amount (step S206), and PI signal detection is carried out subsequently (step S207). When the PI signal is not detected in step S207 (when the result of step S208 is NO), the power of the wireless unit and a part of the digital unit is turned off and is put to a dormant state (step S213).

When the PI signal is detected in step S207 (when the result of step S208 is YES), the process of steps S209 to 210 is carried out during period T24 in FIG. 38. In other words, the frequency offset of a symbol for paging is compensated by using the frequency offset amount estimated in step S205 (step S209), and a paging signal is detected subsequently (step S210).

When the paging signal is not detected in step S210 (when the result of step S211 is NO), the power of the wireless unit and a part of the digital unit is turned off and is put to a dormant state (step S213). When the paging signal is detected (when the result of step S211 is YES), wireless communication is initiated during period T25 in FIG. 38 (step S212).

(Third Frame Structure and Receiving Sequence)

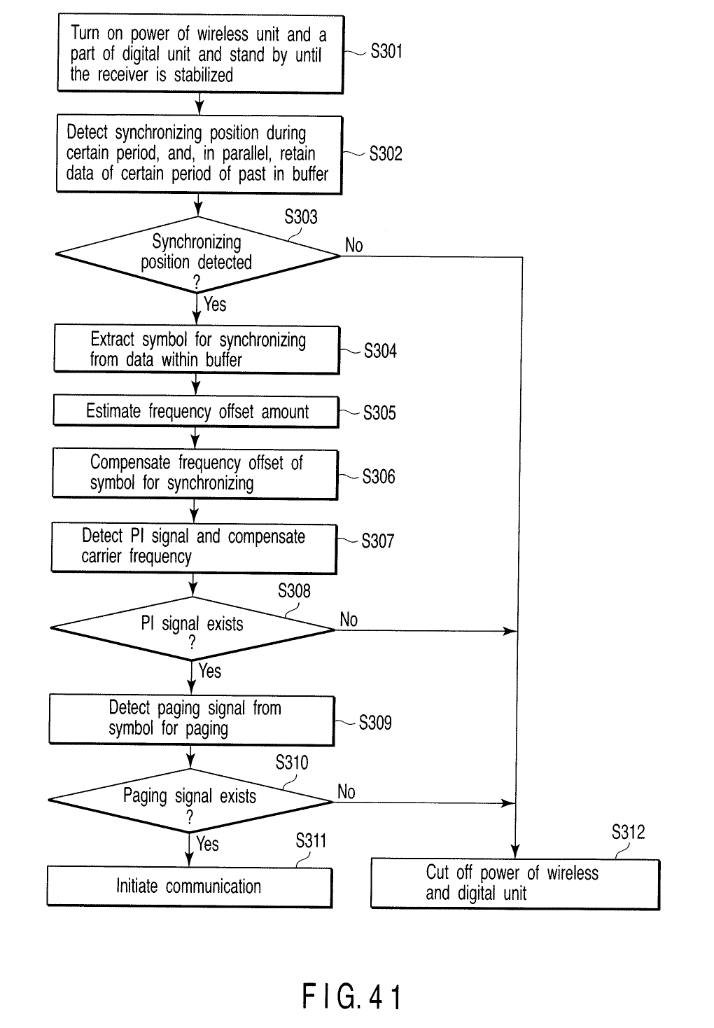

Next, other frame structures and receiving sequences in the case where a low occurrence signal L is a PI signal are explained using FIGS. 40 and 41. As shown in FIG. 40, a synchronizing symbol in which the low occurrence signal is a PI signal is inserted in the OFDM signal. In the example of FIG. 38, a symbol for paging, which includes a paging signal, is inserted immediately after the synchronizing symbol. However, in the example of FIG. 40, the symbol for paging is inserted after a blank period subsequent to the synchronizing symbol. The output frequency of a synthesizer can be compensated by making use of this blank period.

Now, in explanation of the receiving sequence in FIG. 41, the process of steps S301 to S306 in FIG. 41 is almost the same as steps S101 to S106 in FIG. 36 and steps S201 to 206 in FIG. 39. That is, the wireless unit 202 and a part of the digital unit are powered on and put on standby until the receiver is stabilized (step S301). The process of step S301 is carried out during period T31 in FIG. 40. Subsequently, the synchronizing position is detected during a fixed period of time T32 in FIG. 40, and, in parallel, data of a certain fixed period of the past is retained at buffers 207 and 222 (step S302). Here, the fixed period of time T32 is set so as to include time before and after when the arrival of the synchronizing symbol is predicted from information obtained beforehand. As a result of step S303, if the synchronizing position (symbol timing) is not detected during the fixed period T32 (when the result of step S303 is NO), the power of the wireless unit 202 and a part of the digital unit is turned off and is put to a dormant state (step S312).

If the symbol timing is detected in step S303 (when the result of step S303 is YES), the process of steps S304 to 307 is carried out during the period T33 in FIG. 40. In other words, the synchronizing symbol is extracted from data within the buffer 207 on the basis of the synchronizing position (symbol timing) detected in step S303 (step S304). Detection (estimation) of the frequency offset amount is carried out using the extracted synchronizing symbol (step S305). Frequency offset of the synchronizing symbol is compensated by using the detected frequency offset amount (step S306), and PI signal detection and carrier frequency offset compensation are carried out subsequently (step S307). When the PI signal is not detected in step S307 (when the result of step S308 is NO), the power of the wireless unit and a part of the digital unit is turned off and is put to a dormant state (step S312).

When compensating an output frequency of a synthesizer, a certain period is required for the output frequency to converge. During such period a receiving signal cannot be received properly. Therefore, in the receiving sequence shown in FIG. 40, the symbol for paging is made to arrive after the output frequency of the synthesizer is stabilized by compensation via period T33.

When the PI signal is detected in step S307 (when the result of step S308 is YES), the paging signal is detected from the symbol for paging during period T34 in FIG. 40 (step S309). In the receiving sequence shown in FIG. 39, a compensation of the frequency offset was required in step S206. However, in the receiving sequence of FIG. 40, the carrier frequency (output frequency of the synthesizer) is compensated in step S307, therefore, frequency offset does not have to be compensated.

When the paging signal is detected in step S309 (when the result of step S310 is YES), wireless communication is initiated in period T35 in FIG. 40 (step S311).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless transmitter for transmitting a signal of an orthogonal frequency division multiplexing (OFDM) symbol, comprising:
a first generator to generate a plurality of first signals each including a stationary signal;
a second generator to generate a plurality of second signals whose total power is less than that of the first signals;
an allocation unit configured to allocate the first signals to the ±N*k (N: an integral number not less than or equal to 2, k=1, 2, . . . ) th first subcarriers of a synchronizing symbol and to allocate the second signals to at least a part of second subcarriers of the synchronizing symbol, the some second subcarriers excluding a center subcarrier;
a generating unit configured to generate a signal of an OFDM symbol including the synchronizing symbol in which the first signals and the second signals are allocated into the first subcarriers and the second subcarriers; and
a transmission unit configured to transmit the signal of the OFDM symbol.

2. A transmitter according to claim 1, wherein the second signals are formed of non-stationary signals, and the allocation unit is configured to allocate the second signals to at least a part of the second subcarriers.

3. A transmitter according to claim 1, wherein the second signals are formed of stationary signals, and the allocation unit is configured to allocate the second signals to the part of the second subcarriers.

4. A transmitter according to claim 1, wherein the second signals include non-stationary third signals and stationary fourth signals, and the allocation unit is configured to allocate the third signals to the part of second subcarriers and to allocate the fourth signals to the remaining ones of the second subcarriers other than the part of second subcarriers.

5. A transmitter according to claim 1, wherein the plurality of subcarriers are numbered in ascending order in directions of increasing and decreasing frequencies with respect to the center frequency, the second signals are formed of non-stationary signals, and the allocation unit is configured to allocate the second signals preferentially to subcarriers of the second subcarriers, that each have a subcarrier number whose absolute value is larger than a certain fixed value.

6. A transmitter according to claim 1, wherein the plurality of subcarriers are numbered in ascending order in directions of increasing and decreasing frequencies with respect to a center frequency, the second signal is a non-stationary signal, and the allocation unit is configured to allocate the second signals preferentially to subcarriers of the second subcarriers, that each have a subcarrier number whose absolute value is smaller than a certain fixed value.

7. A transmitter according to claim 2, wherein an occurrence frequency of each of the non-stationary signals is less than a threshold value.

8. A transmitter according to claim 4, wherein an occurrence frequency of each of the fourth signals is less than a threshold value.

9. A transmitter according to claim 5, wherein an occurrence frequency of each of the non-stationary signals is less than a threshold value.

10. A transmitter according to claim 6, wherein an occurrence frequency of each of the non-stationary signals is less than a threshold value.

11. A transmitter according to claim 2, wherein the non-stationary signals each are formed of a paging signal for paging other wireless transmitters from the wireless transmitter.

12. A transmitter according to claim 4, wherein the fourth signals each are formed of a paging signal for paging other wireless transmitters from the wireless transmitter.

13. A transmitter according to claim 5, wherein the non-stationary signals each are formed of a paging signal for paging other wireless transmitters from the wireless transmitter.

14. A transmitter according to claim 6, wherein the non-stationary signals each are formed of a paging signal for paging other wireless transmitters from the wireless transmitter.

15. A transmitter according to claim 1, wherein the stationary signals each are formed of at least either one of an information signal and a known signal.

16. A transmitter according to claim 3, wherein the stationary signals each are formed of at least either one of an information signal and a known signal.

17. A transmitter according to claim 4, wherein the fourth signals each are formed of at least either one of an information signal and a known signal.

18. A method for allocating a signal to each subcarrier of an orthogonal frequency division multiplexing (OFDM) synchronizing symbol possessing a plurality of subcarriers, comprising:
allocating first signals generated in steady to ±N*k (N: an integral number not less than 2, k=1, 2, . . . ) th first subcarriers of the synchronizing symbol; and
allocating second signals to at least a part of second subcarriers of the synchronizing symbol, which exclude a center subcarrier, the second signals whose total power is smaller than that of the first signals.

19. A wireless receiver comprising:
a reception unit configured to receive the signal of the OFDM symbol transmitted from the transmitter according to claim 1; and
a processing unit configured to carry out a synchronizing process between the wireless transmitter and the wireless receiver by using a signal of the synchronizing symbol included in the signal of the received OFDM symbol.
